(19) United States
(12) Patent Application Publication
(10) Pub. No.: US 2003/0023901 A1
(43) Pub. Date: Jan. 30, 2003

(54) Method for analyzing serial bus traffic for debugging systems

(76) Inventors: Stephen Patrick Hack, Fort Collins, CO (US); David R. Maciorowski, Parker, CO (US); John A. Morrison, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 09/917,004

(22) Filed: Jul. 27, 2001

(51) Int. Cl. H04L 1/22; G06F 11/30

(52) U.S. Cl. 714/25; 714/9; 714/811

(57) ABSTRACT

A method of debugging a system by analyzing transactions of a serial intra-system bus is particularly applicable to IIC or SPI intra-system busses. The method includes steps of capturing frames of the bus in a capture data file, extracting frames from the capture data file; checking frames for out-of-bounds addresses; and decoding an address of frames to identify a particular slave device type. Once a particular device type is identified, state changes indicated in frames are tracked with a computer model of the slave device; and state error information is recorded when frames indicate state changes that are not permissible state changes of the slave device.

### FIELD OF THE INVENTION

The invention relates to the field of debugging microcontroller systems that incorporate serial busses. In particular, the invention relates to methods and software for analyzing traffic on in-system IIC (or I2C) serial busses to detect and solve system problems

### BACKGROUND OF THE INVENTION

Serial communications busses of the separate-clock-and-data type have become commonly used for communication between integrated circuit components of a system. Serial busses of this intra-system type include the IIC (initially known as the Inter-IC Bus, now widely known as I2C) and SPI busses. Links of this type can be implemented without need of precision timing components at each integrated circuit on the bus and typically operate under control of at least one bus master.

The master typically communicates with one or more slave devices. Many types of commercially available integrated circuits are available with IIC or SPI bus interface apparatus in them, and field programmable gate array devices are configurable to implement IIC or SPI bus interfaces along with other logic. Commercially available integrated circuits with IIC or SPI interfaces include digital-to-analog converters, analog-to-digital converters, pulse-width modulators, EEPROM memory devices, system clock circuits, microcontrollers, parallel and serial port circuits, display interfaces, and other system components.

Serial busses typically transfer data in a hardware-level frame that usually includes address information to select a source or destination in a slave as well as data read or written by the master. Frames of IIC devices also incorporate address information for selecting a particular slave of potentially several slave devices on a bus.

It is known that IIC frames may encapsulate higher-level protocols. For example, if a parallel printer interface device communicates with a processor over an IIC bus, printer interface protocol transactions are encapsulated into IIC bus transactions. Similarly, a network device may connect to a processor over an IIC bus, with 10/100 Base-T Ethernet encapsulated onto IIC transactions. Such higher-level protocols may in turn encapsulate still higher level protocols. For example, TCP-IP internet protocol could be encapsulated within Ethernet transactions, in turn encapsulated in IIC transactions.

A particular protocol that can be encapsulated on an IIC bus is the bUSBoy Protocol. The bUSBoy protocol is of particular utility for communications between system management processors of multiple cabinets in a large system. System management processors may interface to system functions including, but not limited to, power supply voltage monitors, temperature sensors, fan controls, and fan speed. The system management processor in turn interfaces through appropriate hardware, which may include one or more bus bridges, to other processors of the system. System management processors monitor system functions and protect the system by altering fan speeds, by instructing the system to operate in particular modes, including shutdown, or by other means known in the art.

Similarly, state changes of an IIC slave device are detectable in frames of the IIC bus that communicate between the IIC slave and an IIC master.

Systems incorporating such busses may have problems, or bugs, despite the best efforts of system designer. Bugs are especially prevalent in the early stages of prototype development, but may be detected at other times in product life cycles even after systems are in production. Examination of data on serial busses of the system may be useful in solving such bugs.

There are commercially available logic analyzers having the ability to observe hardware-level transactions on serial busses of this type. Commercial IIC analyzers typically can recognize frames addressed by a master to one or more slave devices, and capture and/or display the address and data of those frames.

It is known that such commercially available analyzers may capture large volumes of data. It is also known that engineers may have difficulty locating data relevant to a particular bug when that data is buried in a large volume of largely irrelevant data.

It is therefore desirable to filter captured data to identify captured data frames relevant to particular higher-level protocols encapsulated on an IIC serial bus, isolate that data, and interpret the higher level protocol. It is also desirable to identify violations of the higher level protocol, and extract the information being transferred through that protocol. Protocol violations can include extra responses, checksum or CRC errors, and other errors. This process is known herein as looking behind the IIC bus to analyze the encapsulated protocol.

It is also desirable to look behind the IIC bus to track state changes in particular devices of the system.

While no commercially available IIC analyzers known to the inventors look behind the IIC bus to analyze either stage changes in devices or an encapsulated protocol, some ethernet analyzers are known to look behind ethernet hardware layers to extract and validate a few common, encapsulated, protocols such as TCP-IP.

### SUMMARY OF THE INVENTION

A commercially available serial bus analyzer is used to capture a large volume of transactions on an in-system serial bus. This data is filtered to identify IIC transactions relevant to particular IIC slave devices.

The data is further filtered to identify information relevant to particular state changes of the particular IIC slave devices. These state changes are tracked against a model of the particular IIC slave devices. State change sequence violations, or changes to unexpected states including error states, of those IIC slave devices are then identified and flagged for view by an engineer.

The data is also filtered to identify frames relevant to particular encapsulated protocols. Protocol and data information is extracted from these frames. The protocol information is tracked against a model of the protocol, and protocol violations, including extra responses and CRC or checksum errors, are identified and flagged for view by an engineer. Data encapsulated with that protocol information is also extracted. CRC or checksums of that protocol are verified. The extracted data may be recursively analyzed for any second-level encapsulated protocols.

An embodiment of the invention incorporates a reference library of component models that may be selected and used for state tracking and look-behind purposes. It is known that there is a great variety of IIC and SPI compatible device types, of which a considerable number may be present on any one bus

### BRIEF DESCRIPTION OF THE DRAWINGS

FIG. 1 is a block diagram of a prior art computer system incorporating an IIC bus that may require debugging;

FIG. 2, is an illustration of a prior art header of a bUSBoy protocol packet header such as may be encapsulated into a sequence of IIC frames;

FIG. 3, is an illustration of data as captured by a prior art commercial IIC analyzer;

FIG. 4, is a block diagram of apparatus of the present invention for debugging the system of FIG. 1;

FIG. 5, is a flowchart of the method of the present invention; and

FIG. 6, is a flowchart detailing a portion of a device model capable of tracking an encapsulated protocol.

### DETAILED DESCRIPTION OF THE EMBODIMENTS

A large computer system 100, as known in the art, has a first cabinet 102 containing a system management subsystem 101. System management subsystem 101 has a primary system management processor 104, and may contain a backup system management processor 106 that can serve as bus masters on an IIC bus 108. IIC bus 108 interfaces management processors 104, 106 to an assortment of devices, including fan speed monitors 110, a system configuration EEPROM and clock device 112, analog-to-digital converters 114 for monitoring voltages, a network interface 116, and a system processor interface 118. A debug header 119 is provided for connecting external test apparatus to the IIC bus 108 of the system management subsystem 101.

The first cabinet 102 also contains several system processors 120, associated memory systems 122, and peripheral devices and interfaces 124. A second cabinet 130 has additional storage devices and I/O subsystems 132, and a second cabinet system management subsystem 134. System management subsystem 101 communicates with the second cabinet system management subsystem 134 over a local network 136.

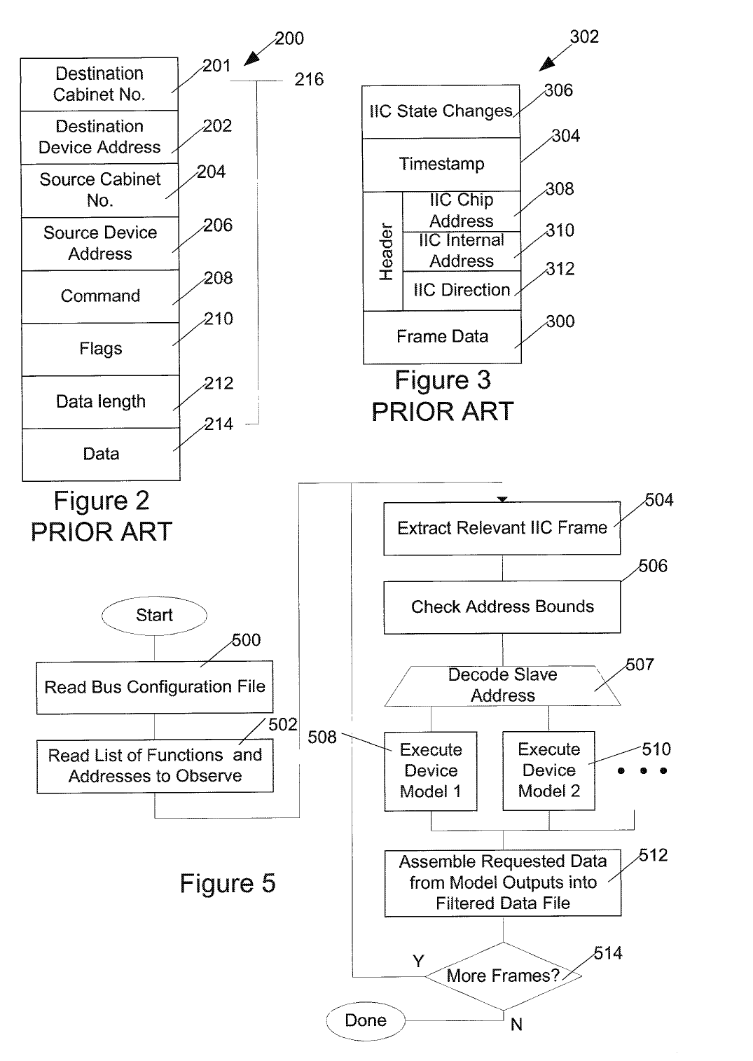

A packet 200 (FIG. 2) of a prior art higher level protocol, such as the bUSBoy protocol, has destination addresses of a cabinet 201 and device 202 to receive the packet 200. These are followed by source addresses of a cabinet 204 and device 206 from which the packet 200 was transmitted, and command 208 and flag 210 information. Next is a data byte count 212, and data 214 relevant to the command 208.

When the packet 200 is encapsulated on an IIC bus, the packet, including its header 216, is distributed as data in one or more IIC frames. These frames may be captured by an IIC analyzer, where the packet is distributed as data 300 (FIG. 3) in one or, more frequently, more than one, captured IIC frames 302. Each IIC captured frame has a timestamp 304 and IIC state change 306 information, as well as a destination device address 308, a destination address within the device 310, and bus direction information 312.

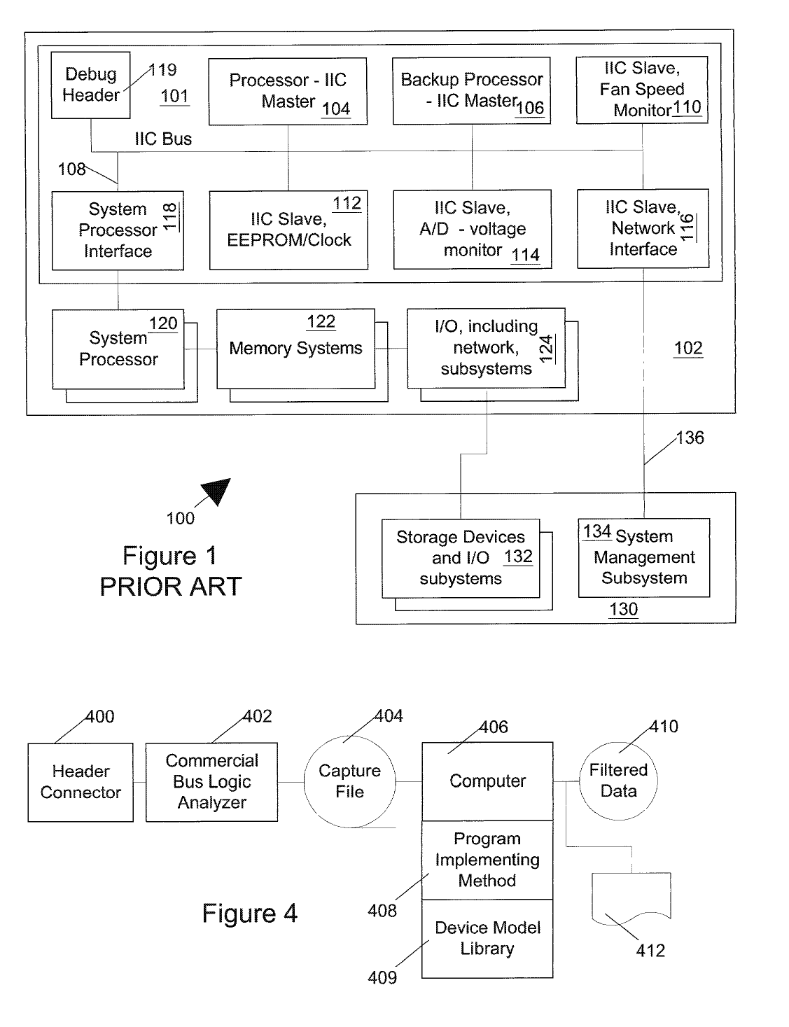

A system for analyzing an IIC bus according to the present invention has a header connector 400 (FIG. 4) for connecting to the debug header 119 (FIG. 1) of a system to be debugged. Header connector 400 is coupled to a commercial IIC bus analyzer 402, which is configured to capture IIC transactions addressed to one or more IIC slave devices that could be related to a bug, such as devices 110, 112, 114, or 116, of the system. IIC bus analyzer 402 captures a capture file 404, indicative of bus transactions which is input to a computer 406 executing the program 408 implementing the filtering method. Computer 406 also has a device model library 409 containing state-flow level models of at least some devices 110, 112, 114, or 116, of the system. The computer 406 generates a filtered data file 410 and reports 412.

In addition to an implementation of a state diagram of each device modeled, each model in device model library 409 includes address range boundary information for the device.

Once data is captured, the program 408 begins by processing its command line options (not shown) and reading 500 (FIG. 5) a bus configuration file. The bus configuration file includes device type, and address location of, each master and slave on the IIC bus; it is used to locate and configure models from the model library 409 of these devices. The located and configured models are activated and assembled into an overall model (not shown) of the IIC bus 108.

Next, the program 408 reads 502 a list of functions to observe on the bus. This list may change as a system is being debugged, and contains a specification of information that is expected to be of use to an engineer at a particular stage of system debug and development. This list may specify that only transactions to certain IIC device addresses are to be examined. This list may also specify a particular time window of captured events to analyze.

The program 408 then scans the data capture file 404 to extract 504 a frame of interest. The IIC Chip address and IIC internal addresses are checked 506 against address limits and errors recorded if they are out of bounds. Then, the IIC Chip Address field 308 of the frame is decoded 507 to determine which device model, such as device model 508, of the active device models 508, 510, is appropriate for use in interpreting that frame. After executing the selected device model 508, the program 408 assembles 512 error and result log information, if any, from the device models into a filtered data file 410 and a report 412.

Once processing of a frame is complete, a test 514 is made to identify remaining unprocessed, relevant, frames in the capture file 404. If any remain, they are processed as heretofore described.

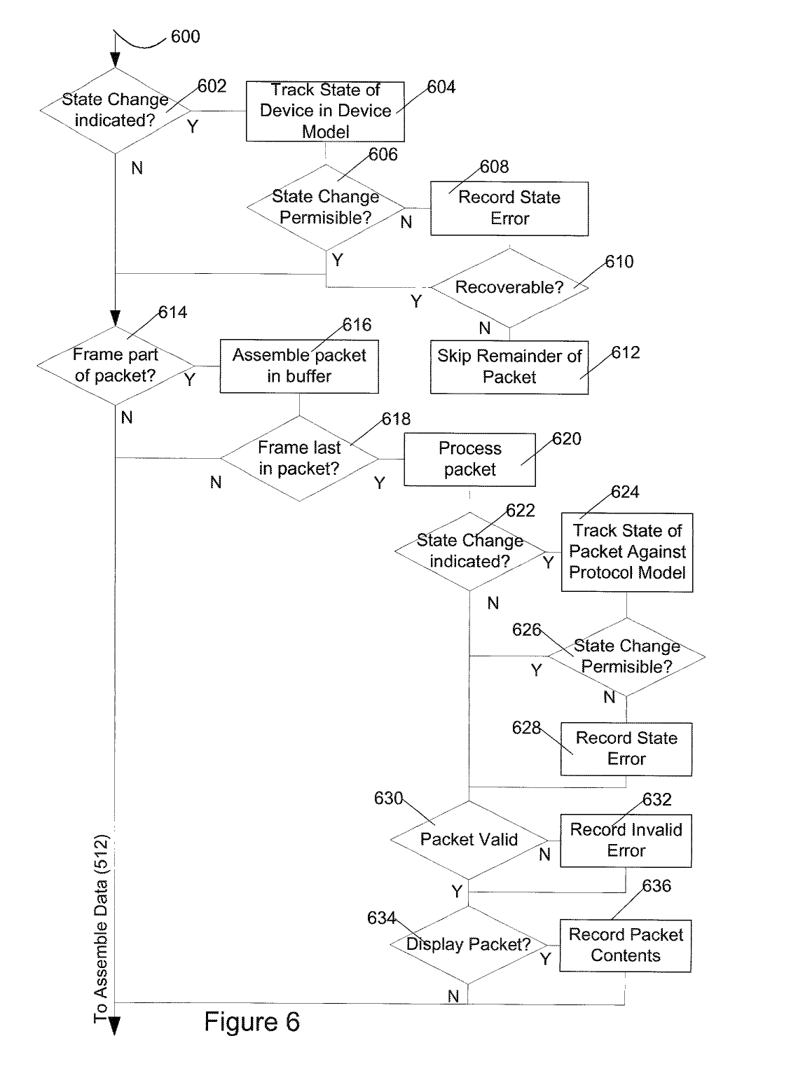

A device model 508 for interpreting frames addressed to a device capable of handling an encapsulated protocol begins 600 (FIG. 6) by checking frames for indications of a state change 602 at the device. These state changes are tracked 604 against an internal model of the device to determine if they are permitted state changes. If 606 they are not permitted state changes, a state error is recorded 608. Upon detecting a state error, a check is made to see if any encapsulated packet is recoverable 610, if it is not the remainder of the packet is skipped 612. If 602 no state change was indicated, if a state change was permissible 606, or if 610 a state change indicated a recoverable error, a check is made to determine if 614 the frame encapsulates a portion of a packet. If 614 the frame encapsulates part of a packet, data is extracted from the frame and assembled 616 in a packet buffer. If 618 the frame is not the last frame encapsulating the packet, the device model passes on to the step of assembling data 512 into the filtered data file and reports.

If 618 the frame encapsulates the last frame of a packet the packet is processed 620. If 622 the packet indicates a higher level protocol state change, that state change is tracked 624 against a model of the higher level protocol. If 626 the state change is inconsistent with the model, a state inconsistency error is recorded 628. The model of the higher level protocol keeps track of packet types and responses expected to certain kinds of packets, a state inconsistency error is therefore recorded 628 if an extra response packet is received. The packet is then checked for validity 630, through methods such as verifying a checksum or CRC; any validity error is recorded 632. Then, the packet is checked 634 against capture filters; if data capture is indicated the packet is recorded 636. Finally, the device model passes on to the step of assembling data 512 into the filtered data file and reports.

It has been found that some device models, especially those for complex devices or devices supporting encapsulated protocols, must be recursively developed. Models are therefore redefined as debugging proceeds and discrepancy data is collected. When differences between the device state models and captured data prove to be a result of an incomplete or incorrect model, the model is revised.

While the invention has been particularly shown and described with reference to a preferred embodiment thereof, it will be understood by those skilled in the art that various other changes in the form and details may be made without departing from the spirit and scope of the invention. It is to be understood that various changes may be made in adapting the invention to different embodiments without departing from the broader inventive concepts disclosed herein and comprehended by the claims that follow.

What is claimed is:

1. A method of debugging a system by analyzing transactions of a serial intra-system bus comprising the steps of:
capturing frames of a serial intra-system bus in a capture data file;
extracting frames from the capture data file;
checking frames for out-of-bounds addresses;
decoding an address of frames to identify a particular slave device;
tracking state changes indicated in frames with a computer model of the slave device; and
recording state error information when state changes indicated in frames are not permissible state changes of the computer model.

2. The method of claim 1, further comprising the step of assembling packets that are encapsulated in the frames.

3. The method of claim 2, further comprising the step of validating assembled packets.

4. The method of claim 3, further comprising the step of determining if the state changes are permissible state changes.

5. The method of claim 4, wherein the step of determining if the state changes are permissible state changes is performed by tracking state changes indicated in the assembled packets in a protocol model, and comparing state changes against permitted state changes of the model.

6. A memory device containing machine readable code for analyzing captured frames from a serial intra-system bus, the machine readable code comprising code for:
extracting frames from the capture data file;
checking frames for out-of-bounds addresses;
decoding an address of frames to identify a particular slave device;
tracking state changes indicated in frames with a computer model of the slave device; and
recording state error information when state changes indicated in frames are not permissible state changes of the computer model.

7. The method of claim 6, further comprising the step of assembling packets that are encapsulated in the frames.

8. The method of claim 7, further comprising the step of validating assembled packets.

9. The method of claim 8, further comprising the step of determining if the state changes are permissible state changes.

10. The method of claim 9, wherein the step of determining if the state changes are permissible state changes is performed by tracking state changes indicated in the assembled packets in a protocol model, and comparing state changes against permitted state changes of the model.
